(19) United States
(12) Patent Application Publication
(10) Pub. No.: US 2012/0212477 A1
(43) Pub. Date: Aug. 23, 2012

(54) Fast Haze Removal and Three Dimensional Depth Calculation

(75) Inventors: Gene A. Grindstaff, Decatur, AL (US); Sheila G. Whitaker, Gurley, AL (US)

(73) Assignee: INTERGRAPH TECHNOLOGIES COMPANY, Las Vegas, NV (US)

(21) Appl. No.: 13/030,534

(22) Filed: Feb. 18, 2011

(51) Int. Cl. G06T 15/00; G06K 9/00; G09G 5/02

(52) U.S. Cl. 345/419; 345/589; 382/167; 382/154

(57) ABSTRACT

A computer-implemented method of processing digital input image data containing haze and having a plurality of color channels including at least a blue channel, to generate output image data having reduced haze, includes receiving in a first computer-implemented process, digital input image data, and generating, in a second computer-implemented process, digital output image data based on the digital input image data using an estimated transmission vector for the digital input image data. The estimated transmission vector is substantially equal to an inverse blue channel of the digital input image data, and the digital output image data contains less haze than the digital input image data. The method also includes outputting the digital output image data via an output device.

### TECHNICAL FIELD

The present invention relates to image processing, and more particularly to image enhancement and generation of three-dimensional image data.

### BACKGROUND ART

Many color photography images, particularly those recorded outdoors using either an analog or digital sensing device, have haze or fog that obscures the objects that are being recorded. A method is needed that allows rapid removal of the haze from the color image. Near real-time performance is desired, but has not been achievable using any realistic image processing calculation techniques currently available. It is known that haze may be represented by the Koschmieder equation, however solutions of this equation require numerous calculations, the solution of which is inappropriate for real-time enhancement of either still photograph or video sequences.

### SUMMARY OF THE EMBODIMENTS

A first embodiment of the present invention is a computer-implemented method of processing digital input image data containing haze and having a plurality of color channels including at least a blue channel, to generate output image data having reduced haze. The method includes receiving the digital input image data in a first computer-implemented process. The method also includes generating, in a second computer-implemented process, digital output image data based on the digital input image data using an estimated transmission vector for the digital input image data. The estimated transmission vector is substantially equal to an inverse blue channel of the digital input image data. The digital output image data contains less haze than the digital input image data. The method also includes outputting the digital output image data via an output device.

In a related embodiment, the blue channel is normalized. Normalizing the blue channel may include dividing the values of the blue channel by a constant that represents light scattered in the input image data. The input image data may be a photographic image. Generating digital output image data may include solving the equation:

I(x,y)=J(x,y)*t(x,y)+A*(1−t(x,y))

to determine a value of J, where I is a color vector of the input image, J is a color vector that represents light from objects in the input image, t is the estimated transmission vector associated with the input image, and A is a constant that represents light scattered in the input image data. Solving the equation may include determining a value of A by subsampling pixels in the digital image data. Determining a value of A may further include determining a selected pixel corresponding to A.

In a further related embodiment, determining a value of A includes determining a minimum value for each of the plurality of color channels for each sampled pixel, determining a selected pixel of the sampled pixels for which the minimum value is a highest minimum value, and determining a value of A based on the selected pixel.

In another related embodiment, determining a value of A includes, dividing the image into a plurality of blocks of a predetermined size. After the image is divided, a pixel is selected having a smallest intensity of the pixels in the block for each of a plurality of blocks of pixels. Determining a value of A further includes determining a pixel of the selected pixels with a greatest intensity, and determining a value of A based on the pixel having the greatest intensity.

In another related embodiment, the digital input image data includes a series of input images, and generating digital output image data includes generating a series of output images having reduced haze.

Another embodiment of the present invention is a computer-implemented method of processing two-dimensional digital input image data having a plurality of color channels including at least a blue channel, to generate three-dimensional output image data. The method includes receiving the two-dimensional digital input image data in a first computer-implemented process. The method also includes generating, in a second computer-implemented process, a depth map of the input image based on an estimated transmission vector is substantially equal to an inverse blue channel of the digital input image data. The method also includes generating, in a third computer-implemented process, three-dimensional digital output image data based on the two-dimensional digital input image data using the depth map and outputting the three-dimensional digital output image data via an output device.

In a related embodiment, generating a depth map includes determining depth values for pixels in the input image based on the formula

d(x,y)=−β*ln(t(x,y)),

where d(x,y) is a depth value for a pixel at coordinates (x,y), β is a scatter factor, and t(x,y) is the transmission vector.

In a further related embodiment, β is determined based on a known distance from a camera that created the input image to an object represented at a predetermined pixel of the input image. The predetermined pixel may be a center pixel.

In another related embodiment, the method also includes generating a three-dimensional haze-reduced image based on the depth map and the digital output image data.

In a related embodiment, generating a series of output images includes generating three-dimensional video output having reduced haze by generating a series of two-dimensional digital images, generating depth maps for the series of digital images, and generating a series of three-dimensional haze-reduced images based on the series of two-dimensional digital images and the depth maps. The three-dimensional haze-reduced images may be further processed to format the image data including the depth maps into a format compatible with three-dimensional rendering on a display device. For example, a standard movie having two dimensional information may be converted into a three dimensional movie.

Another embodiment of the present invention is a computer-implemented method for filtering light scattered as the result of the atmosphere from a photographic image composed of digital data. The method includes determining in a first computer-implemented process, a transmission characteristic of the light present when the photographic image was taken based on a single color. The method also includes applying, in a second computer-implemented process, the transmission characteristic to the data of the photographic image to filter the scattered atmospheric light producing an output image data set. The method also includes storing the output image data set in a digital storage medium.

Another embodiment of the present invention is a computer-implemented method for producing a three-dimensional image data set from a two-dimensional photographic image composed of digital data. The method includes determining, in a first computer-implemented process, a transmission characteristic of the light present when the photographic image was taken based on a single color. The method also includes applying, in a second computer-implemented process, the transmission characteristic to the data of the photographic image to generate a depth map for the photographic image. The method also includes applying, in a third computer-implemented process, the depth map to the photographic image to produce a three-dimensional output image data set. The method also includes storing the output image data set in a digital storage medium. The stored output image data may be stored in either volatile or non-volatile memory and may be further provided to a display device for display of the output image data.

Another embodiment of the present invention is a non-transitory computer-readable storage medium with an executable program stored thereon for processing digital input image data containing haze and having a plurality of color channels including at least a blue channel, to generate output image data having reduced haze. The program instructs a microprocessor to receive, in a first computer-implemented process, the digital input image data. The program also instructs the microprocessor to generate, in a second computer-implemented process, digital output image data based on the digital input image data using an estimated transmission vector for the digital input image data. The estimated transmission vector is substantially equal to an inverse blue channel of the digital input image data, and the digital output image data contains less haze than the digital input image data. The program also instructs the microprocessor to output the digital output image data via an output device.

In a related embodiment, the input image data is a photographic image. Generating digital output image data includes solving the equation:

I(x,y)=J(x,y)*t(x,y)+A*(1−t(x,y))

to determine a value of J, where I is a color vector of the input image, J is a color vector that represents light from objects in the input image, t is the estimated transmission vector associated with the input image, and A is a constant that represents light scattered in the input image data.

In a related embodiment, determining a value of A includes determining a minimum value for each of the plurality of color channels for each sampled pixel, determining a selected pixel of the sampled pixels for which the minimum value is a highest minimum value, and determining a value of A based on the selected pixel.

In a further related embodiment, determining a value of A includes selecting a pixel having a smallest intensity of the pixels in the block for each of a plurality of blocks of pixels. Determining a value of A also includes determining a pixel of the selected pixels with a greatest intensity and determining a value of A based on the pixel having the greatest intensity.

Another embodiment of the present invention is a non-transitory computer-readable storage medium with an executable program stored thereon for processing two-dimensional digital input image data having a plurality of color channels including at least a blue channel, to generate three-dimensional output image data. The program instructs a microprocessor to receive the two-dimensional digital input image data. The program also instructs the microprocessor to generate a depth map of the input image based on an estimated transmission vector is substantially equal to an inverse blue channel of the digital input image data. The program also instructs the microprocessor to generate three-dimensional digital output image data based on the two-dimensional digital input image data using the depth map

In a related embodiment, generating a depth map includes determining depth values for pixels in the input image based on the formula

d(x,y)=−β*ln(t(x,y)),

where d(x,y) is a depth value for a pixel at coordinates (x,y), β is a scatter factor, and t(x,y) is the transmission vector.

Another embodiment of the present invention is an image processing system. The image processing system includes a color input module that receives digital input image data containing haze and having a plurality of color channels including at least a blue channel. The image processing system also includes an atmospheric light calculation module that receives digital input image data from the color input module and calculates atmospheric light information. The image processing system also includes a transmission estimation module that receives the digital input image data from the color input module, receives atmospheric light information from the atmospheric light calculation module, and estimates a transmission characteristic of the digital input image data based on a single color channel. The image processing system also includes an image enhancement module that receives digital input image data, atmospheric light information and the transmission characteristic and generates output image data having reduced haze. The image processing system also includes an output module that receives the output image data from the image enhancement module and outputs the output image data to at least one of a digital storage device and a display.

Another embodiment of the present invention is an image processing system. The image processing system includes a color input module that receives two-dimensional digital input image data having a plurality of color channels including at least a blue channel. The image processing system also includes an atmospheric light calculation module that receives digital input image data from the color input module and calculates atmospheric light information. The image processing system also includes a transmission estimation module that receives the digital input image data from the color input module, receives atmospheric light information from the atmospheric light calculation module, and estimates a transmission characteristic of the digital input image data based on a single color channel. The image processing system also includes a depth calculation module that receives the digital input image data and the transmission characteristic and calculates a depth map using the digital input image data and the transmission characteristic. The image processing system also includes a three-dimensional image generation module that receives the digital input image data and the depth map and generates three-dimensional output image data using the digital input image data and the depth map. The image processing system also includes an output module that receives the three-dimensional output image data and outputs the three-dimensional output image data to at least one of a digital storage device and a display.

### BRIEF DESCRIPTION OF THE DRAWINGS

The foregoing features of embodiments will be more readily understood by reference to the following detailed description, taken with reference to the accompanying drawings, in which:

FIG. 1 is a flow chart of a process for enhancing image data in accordance with embodiments of the present invention.

FIGS. 2 and 2A are flow charts of processes for generating image data using an estimated transmission vector in accordance with embodiments of the present invention.

FIGS. 3 and 3A are flow charts of processes for determining a value for use in estimating the transmission vector used in FIGS. 2 and 2A.

FIG. 4 is a block diagram of an image processing system in accordance with an embodiment of the present invention.

FIGS. 5A-5L are photographic images, each pair of images (FIGS. 5A and 5B, 5C and 5D, 5E and 5F, 5G and 5H, 5I and 5J, and 5K and 5L) show an original hazy image and an enhanced, haze-removed image.

FIGS. 6A-6L are photographic images, each pair of images (FIGS. 6A and 6B, 6C and 6D, 6E and 6F, 6G and 6H, 6I and 6J, and 6K and 6L) show an original image and an image representing depth data.

### DETAILED DESCRIPTION OF SPECIFIC EMBODIMENTS

Definitions. As used in this description and the accompanying claims, the following terms shall have the meanings indicated, unless the context otherwise requires:

A “color channel” of a pixel of digital image data refers to the value of one of the color components in the pixel. For example, RGB-type pixel will have a red color channel value, a green color channel value, and a blue color channel value.

A “color channel” of a digital image refers to the subset of the image data relating to a particular color. For example, in a digital image comprising RGB-type pixels, the blue color channel of the image refers to the set of blue color channel values for each of the pixels in the image.

An “inverse” of a color channel refers to a calculated color channel having values that are complementary to original color channel. Values in a color channel have an associated maximum possible value, and subtracting values of the color channel from the maximum possible value gives the complementary value that makes up the inverse. These values also may be scaled up or down as appropriate for calculation. For example, values in a color channel may be represented for one application as ranging between, e.g., 0-255, but these values may be scaled onto a range of 0 through 1, either before or after calculation of an inverse.

A “color vector” describes color image data by providing color information, such as RGB or YUV data, in association with position data. In two-dimensional image data, e.g., a color vector may define a collection of pixels by associating particular RGB values with (x,y) coordinates of the pixels. The pixel values are arranged in rows and columns which represent their “x” and “y” locations. The intensity value of each color is represented by a number value. The value may be 0.0 to 1.0 which is bit depth independent, or it may be stored as integer value depending on the bit value. For example an eight bit value would be 0 to 255, a ten bit value would be 0 to 1023, and a 12 bit value would be 0 to 4095.

“Haze” in a photographic image of an object refers to anything between the object and the camera that diffuses the light, such as air, dust, fog, or smoke. Haze causes issues in the area of terrestrial photography, where the penetration of large amounts of dense atmosphere may be necessary to image distant subjects. This results in the visual effect of a loss of contrast in the subject, due to the effect of light scattering through the haze particles. The brightness of the scattered light tends to dominate the intensity of the image, leading to the reduction of contrast.

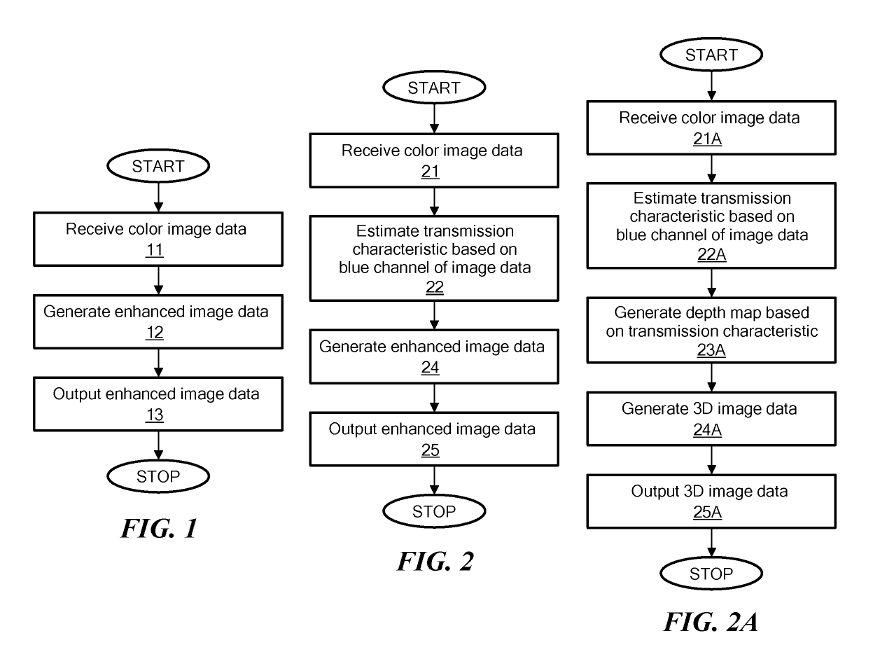

A process for enhancing a photographic image in accordance with embodiments of the present invention is now described with reference to FIG. 1. The photographic image may be digital data originating from a digital source where the digital data containing color information (e.g., RGB, YUV, etc.). An image processing system receives input image data 11. In some embodiments, the input image data may be video data describing a series of still images. The image data may be in any digital image form known in the art, including, but not limited to, bitmap, GIF, TIFF, JPEG, MPEG, AVI, Quicktime and PNG formats. The digital data may also be generated from non-digital data. For example, a film negative or a printed photograph may be converted into digital format for processing. Alternatively, a digital photographic image may be captured directly by digital camera equipment. The image processing system then processes the input image data to generate enhanced image data 12. According to some embodiments, the enhanced image data has a reduced amount of haze relative to the input image data. Reduction of haze in an image enhances information that is present within the image, but that is not readily visible to the human eye in the hazy image. Alternatively, or in addition, the enhanced image data may include depth information. For example, two-dimensional (2D) input image data may be converted into three-dimensional (3D) image data. The image processing system then outputs the enhanced image data 13. The data may be output to storage in a digital storage medium. Alternatively, or in addition, the data may be output to a display where it may be viewed by an observer.

A process for generating haze-reduced image data is now described with reference to FIG. 2. An image processing system receives 21 color image data, as was described above with reference to 11 in FIG. 1. According to the well-known Koschmieder equation, color image data may be modeled as follows:

I(x,y)=J(x, y)*t(x, y)+A*(1−t(x,y)),

where “I” is a color vector of the recorded image, “J” is a color vector that represents light from objects in the image, “A” is a single scalar constant that represents the light scattered from the atmosphere or fog (i.e., “haze”), and “t” is a transmission vector of the scene. In other words, the color (I) of the scene is the result of the combination of the transmitted (t) light (J) from the objects in the scene with the atmospheric light (A). Thus, J* t represents the light from the object attenuated by the atmosphere, and A*(1−t) represents the light scattered by the atmosphere.

The values of “I” are the input values of the color image data, where I(x,y) refers to the pixel at location (x,y) in the image. Each pixel has a plurality of color channel values, usually three, namely red, green, and blue (RGB) although other color systems may be employed. The values of “J” are theoretical values of the color values of the pixels without the addition of any haze. Some of the methods that are described below determine how to modify the known values of “I” to generate values of “J” that will make up a haze-reduced image. Values for “J” can be derived if values can be determined for both A and t(x,y) by solving the Koschmieder equation by algebraic manipulation. Unlike I, J and t, which vary according to coordinates (x,y), A is a single scalar value that is used for the entire image. Conventionally, A can have any value ranging between 0 and 1. For typical bright daylight images, A will be significantly closer to 1 than to 0, including values mostly between about 0.8 and 0.99. For darker images, however, A may be significantly lower, including values below 0.7. Procedures for derivation of A and t(x,y) are described in detail below.

Derivation of values for t(x,y) is useful also because t(x,y) can be used to generate a depth map for an image describing the depth of field to each pixel in the image. This depth map can then be used for a number of practical applications, including generating a 3D image from a 2D image, as shown in FIG. 2A. While the prior art includes techniques for combining a plurality of 2D images to derive a 3D image, it has not been practical to quickly and accurately generate a 3D image from a single 2D image. Embodiments of the present invention, however, can calculate t(x,y) from a single image, which allows the depth, d(x,y), of a pixel to be determined according to the equation:

d(x,y)=−β*ln(t(x, y)),

where β is a scatter factor. In some applications, the scatter factor may be predetermined based on knowledge of the general nature of the images to be processed. In other applications, the scatter factor is calculated based on a known depth for a particular pixel. Because the scatter factor is a constant for a given scene, knowledge of the depth of a single pixel and the transmission value at that pixel allows the scatter factor to be calculated by algebraic manipulation. In applications of, for example, geospatial images from aerial photography (such as from an unmanned aerial vehicle, satellite, etc.) the depth to the center pixel may be known, allowing the scatter factor to be calculated.

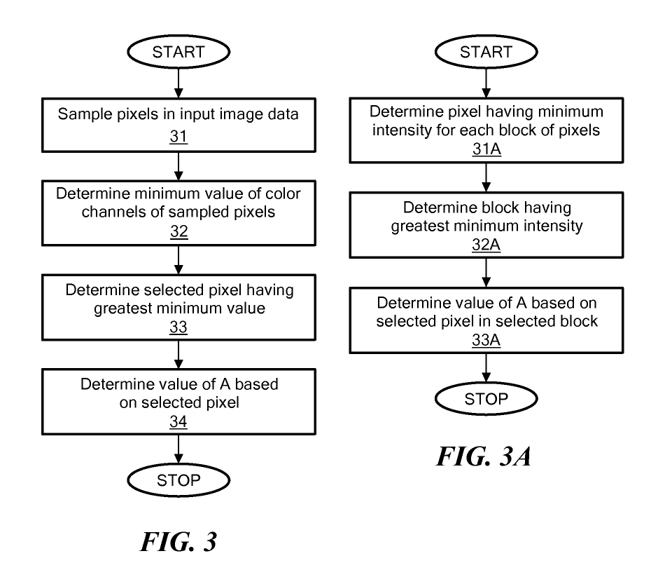

Having received the image data, the image processing system then estimates 22 a transmission characteristic for the image data. The transmission characteristic preferably describes the transmission through the air of light that was present when a photographic image was taken. According to embodiments of the present invention, the transmission characteristic is estimated based on a single color channel in the image data, without the need to consider any other color channels. In an embodiment of the invention, the image data includes at least a red color channel, a green color channel, and a blue color channel, and the transmission characteristic is estimated based on the blue channel. In other embodiments, in which other color systems are used, blue channel values may be derived. Estimating the transmission characteristic also may include calculating a value of A, which is a constant that represents the light scattered from the atmosphere or fog in the image data (i.e., haze), as is described below with reference to FIGS. 3 and 3A.

In some embodiments where the image data is video data including a series of frames of image data, A may be recalculated for each successive image. Calculating A for each successive image provides the most accurate and up to date value of A at all times. In other embodiments, A may be calculated less frequently. In video image data, successive images often are very similar to each other in that much of the color data may be very close to the values of the frames of data that are close in time, representing similar lighting conditions. Accordingly, a value of A that was calculated for one frame of data could be used for several succeeding frames as well, after which a new value of A may be calculated. In certain situations where the atmospheric light of a scene is relatively constant, A may not even need to be recalculated at all after the first time.

According to embodiments of the present invention, the transmission of a scene is estimated as being equal to the inverse of the blue color channel for the images, normalized by the factor “A”:

t(x, y)=1−(I_{blue}(x,y)/A),

Where I_{blue}(x,y) is the blue channel of the pixel at location (x,y).

Experimentation has shown this estimate to be highly accurate, resulting in fast and efficient haze-removal and depth mapping. The blue channel's effectiveness in modeling the transmission can be related to the physics of light scattering in the atmosphere. The atmosphere (or fog) is primarily composed of nitrogen and oxygen and has a natural resonance in the visible spectrum of light in the blue range of color. Thus, when you look at the sky on a clear day the sky appears blue. This is caused by the scatter of the atmosphere and the intense light from the sun. Use of this estimate of the transmission in the Koschmieder equation described above allows for the filtering of undesired scattered light, without attenuating all light in any given spectrum. Thus contrast can be enhanced without loss of detail.

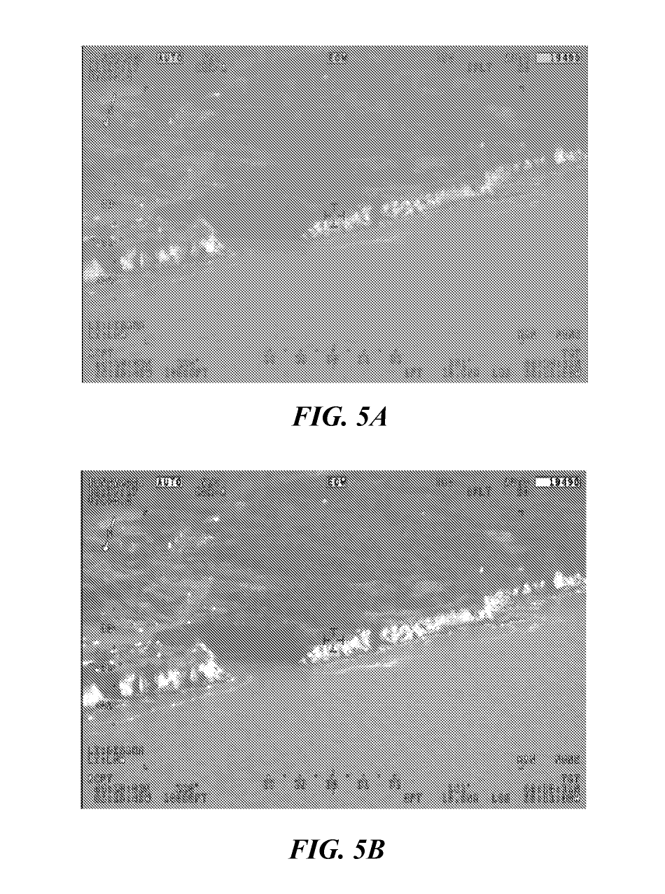

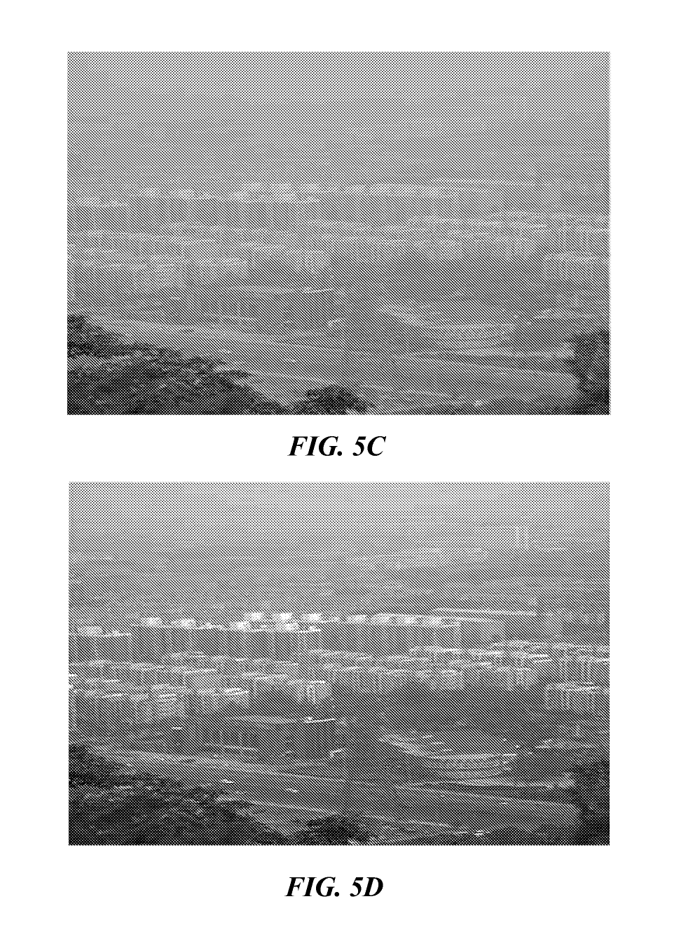

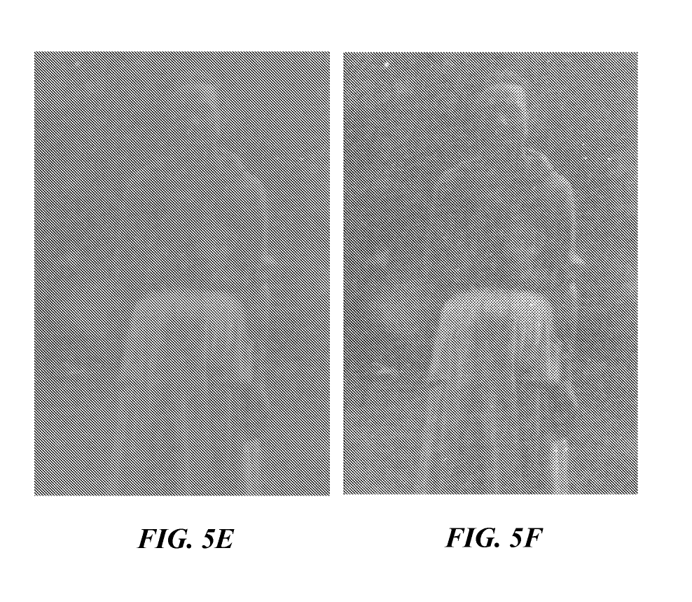

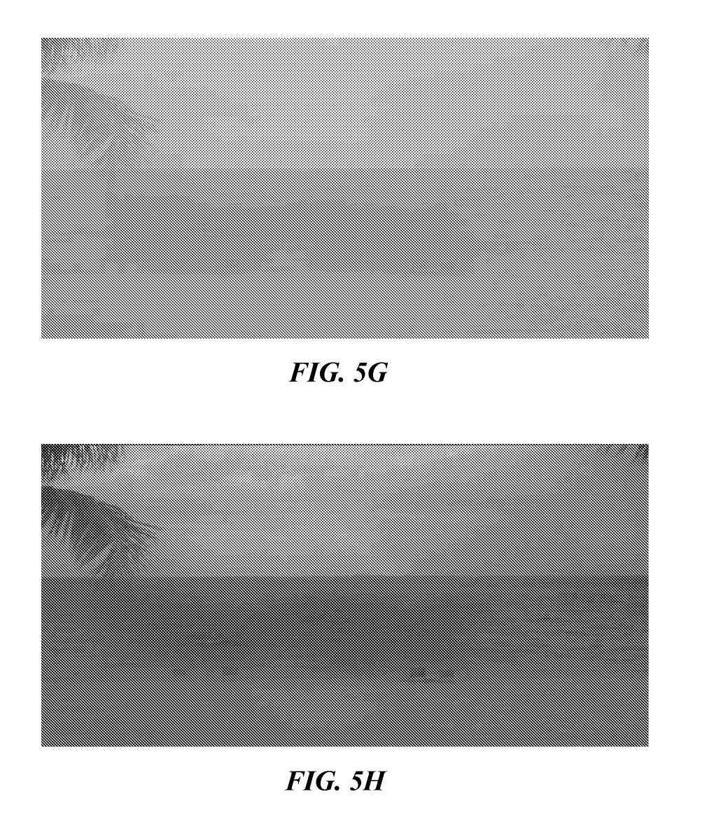

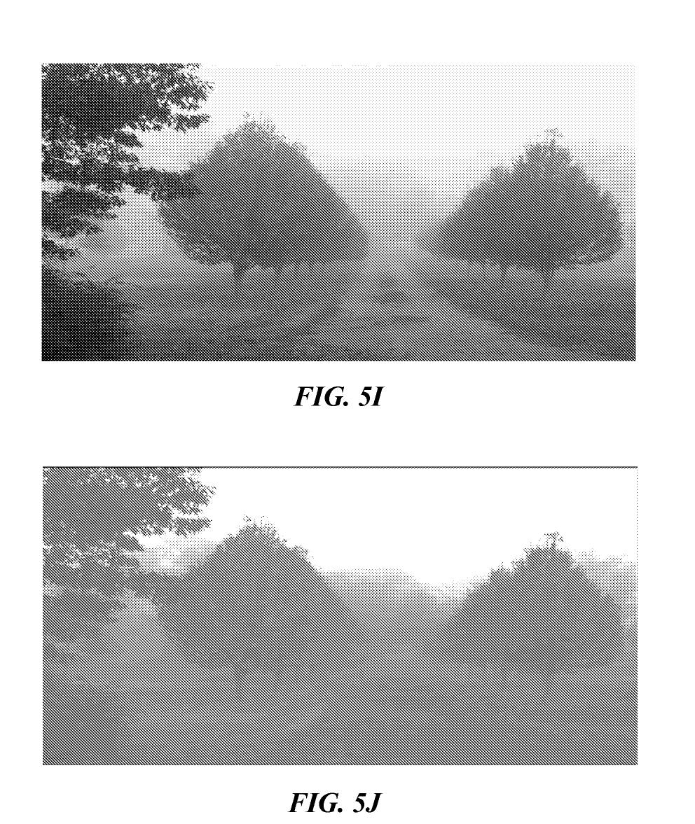

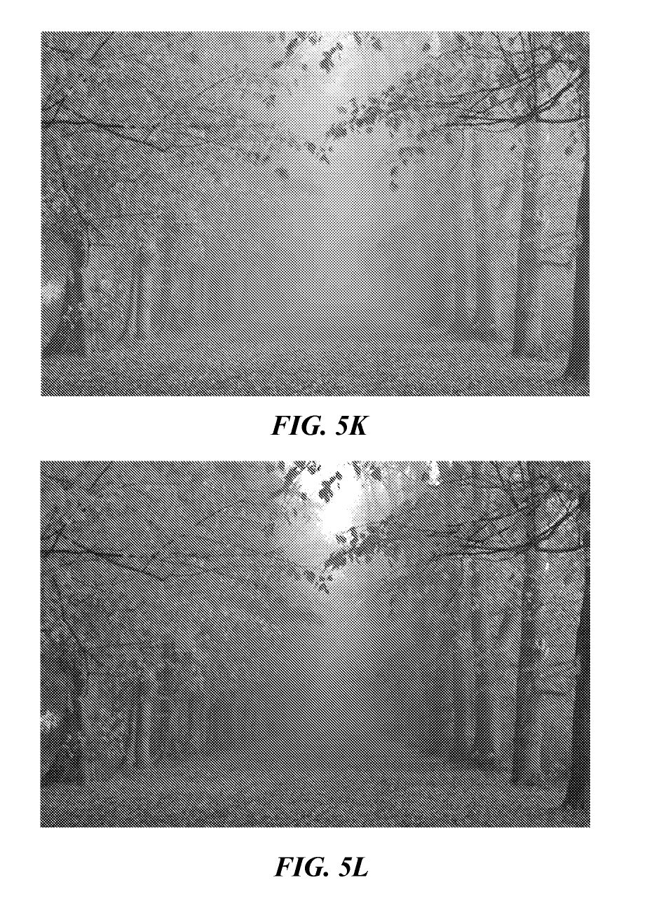

Once the transmission characteristic has been estimated, the image processing system can generate enhanced image data 24. The enhanced image data is then output by an output module of the image processing system 25. The data may be output to any of memory, storage, a display, etc. Exemplary before-and-after images are provided in FIGS. 5A-5L, showing an original image on the top, and showing an enhanced image on the bottom.

The enhanced image data is generated by solving for J in the Koschmieder equation, described above. For example, J may be calculated as shown in the following pseudocode:

```
for y = 0 to height−1
  for x = 0 to width−1
  outpixel(x,y).red=A+(inpixel(x,y).red−A)/(255−inpixel(x,y).blue/255)
  outpixel(x,y).green=A+(inpixel(x,y).green−A)/(255−inpixel(x,y).blue/
  255)
  outpixel(x,y).red=A+(inpixel(x,y).blue − A)/(255−inpixel(x,y).blue/255)
```

The value 255 represents the maximum brightness value of a color channel.

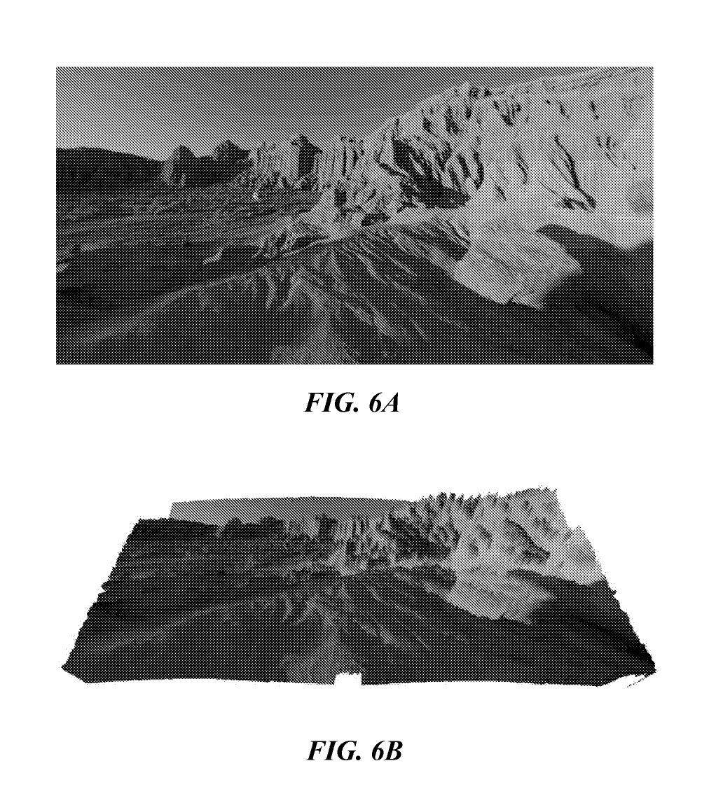

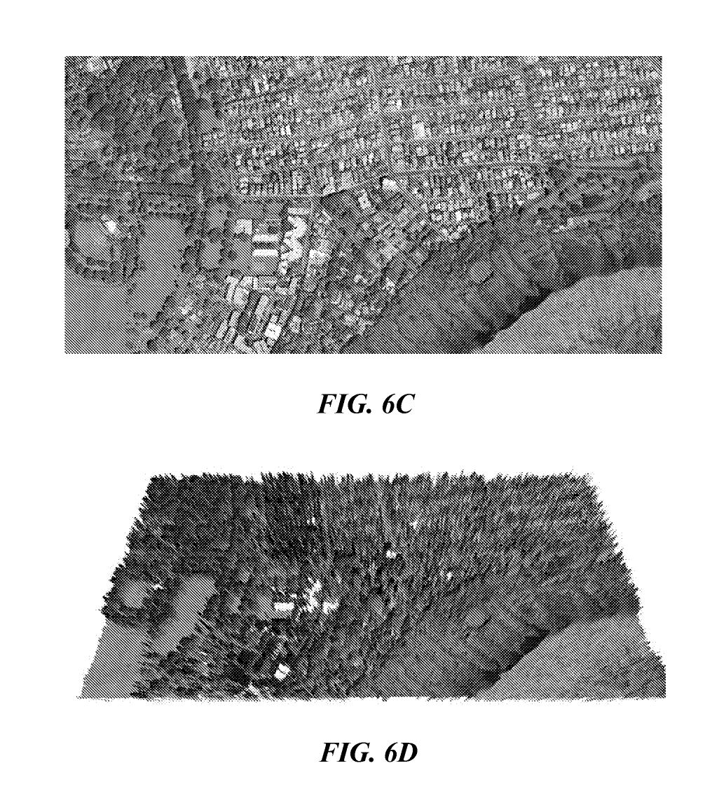

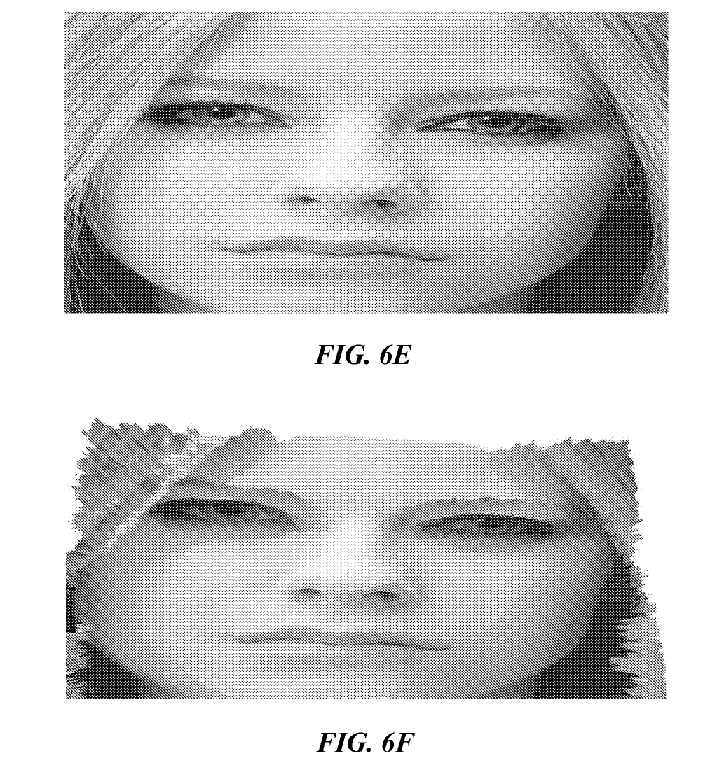

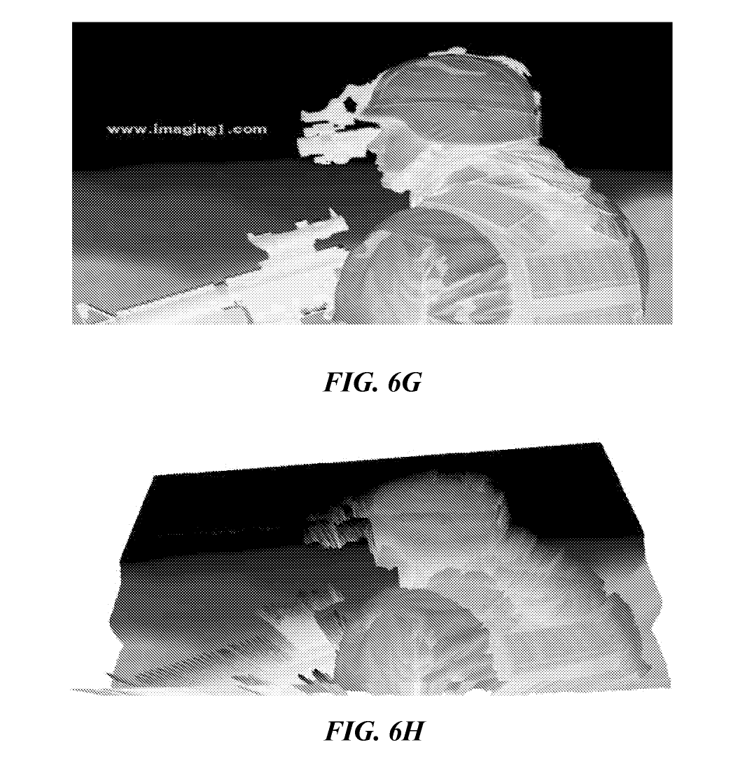

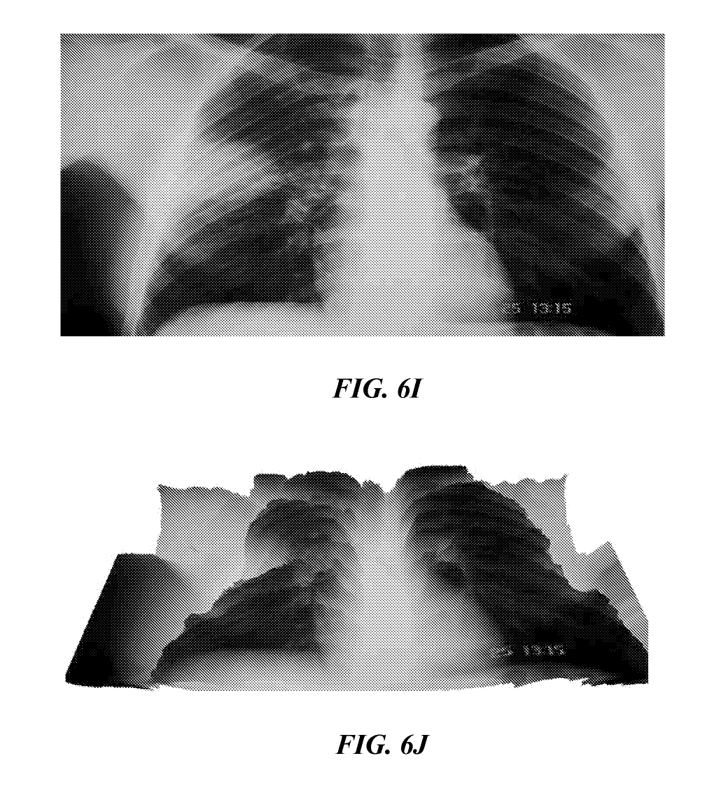

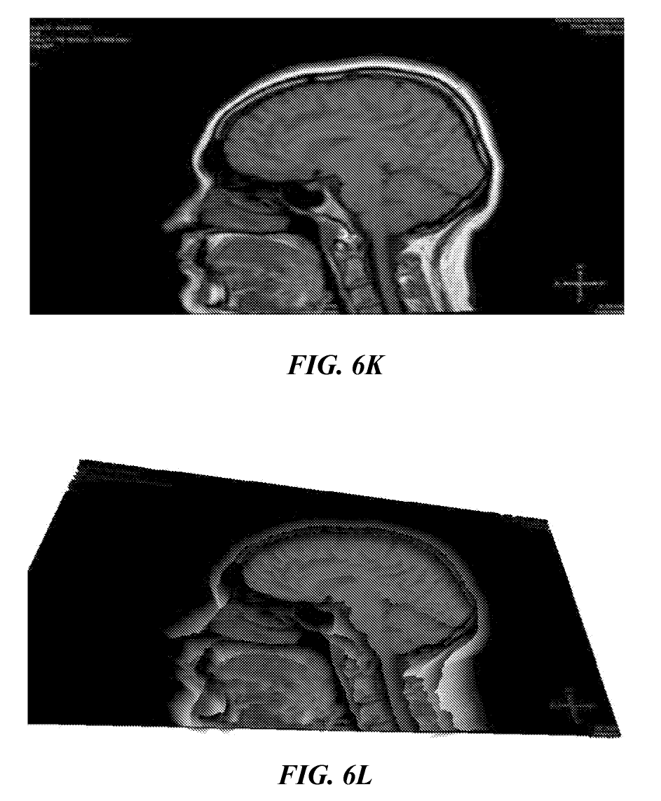

A process for generating 3D image data, similar to the process of FIG. 2, is shown in FIG. 2A. Receiving the image data 21A and estimating the transmission characteristic 22A are performed as described above. In this process, however, the image processing system generates a depth map based on the transmission characteristic 23A. The depth map is then used to generate 3D image data 24A. The 3D image data is then output 25A. Exemplary before-and-after images are provided in FIGS. 6A-6L, showing an original image on the top, and showing an image representing the calculated depth information on the bottom.

Depth maps generated by embodiments of the present invention have numerous practical uses. For example, a movie, recorded as 2D video, may be converted into 3D video, without the need for specialized 3D camera equipment. A depth map may be calculated for each successive frame of video, and the depth maps can then be used to output successive frames of 3D video.

Terrain maps may be generated from aerial photography by creating depth maps to determine the relative elevations of points in the terrain, as shown, for example, in FIGS. 6C and 6D.

Video games may generate highly realistic 3D background images from just a few camera images, without the need for stereoscopic photography or complicated and processor-intensive rendering processes.

Security cameras may intelligently monitor restricted areas for movement and for foreign objects (such as people) by monitoring changes in the depth map of the camera field of vision.

Doctored photographs can be detected quickly and easily but analyzing a depth map for unexpected inconsistencies. For example, if two photographs have been combined to create what appears to be a single city skyline, this combination becomes apparent when looking at the depth map of the image, because the images that were combined are very likely to have been taken at differing distances from the scene. The depth map will have an abrupt change in the depth that is not consistent with the surrounding image's depth. For example, two images that have been blended together will have an abrupt change in depth at the join or blend point that is not natural or consistent with the surrounding image.

Similarly, pictures containing steganography can be detected by analyzing a depth map to find areas of anomalies. Images with steganographic changes may have very abrupt changes in area where the encoding has been altered.

The depth map for generating 3D image data is calculated by solving for d in the equation:

d(x, y)=−β*ln(t(x, y))

as described above. For example, d may be calculated as shown in the following pseudocode:

```
for x = 0 to width−1
  for y = 0 to height−1
  d(x,y) = −beta * ln(t(x,y))
```

A process for determining a value representing atmospheric light in the image data (“A”) for use in estimating the transmission characteristic used in the processes of FIGS. 2 and 2A is now described with reference to FIG. 3. The process of FIG. 3 (as well as alternative processes described below), identifies a particular, representative pixel in the image data, and uses the intensity of the representative pixel or a value from one or more of the color channels of the representative pixel as the value of A. To begin, the image processing system may subsample the image data 31. By subsampling the data, the process of calculation is accelerated, as fewer steps are required. The subsampling frequency can be selected according to the particular needs of a specific application. By subsampling at a greater frequency, i.e., including more data in the calculation, processing speed is sacrificed for a possible improvement in accuracy. By subsampling at a lower frequency, i.e., including less data in the calculation, processing speed is improved, but accuracy may be sacrificed. One embodiment that has been found to provide acceptable accuracy and speed subsamples every sixteenth pixel of every sixteenth row. Thus, in a first row every sixteenth pixel will be considered in the calculation. None of the pixels in any of rows two through sixteen is included in the calculation. Then in the seventeenth row (row 1+16=17), every sixteenth pixel is considered. The subsampling process continues for the thirty-third row (17+16=33), and so on through an entire image. Subsampling frequencies often may be selected to be powers of two, such as eight, sixteen, thirty-two, etc., as use of powers of two may be more efficient in certain programming implementations of the image processing. Other subsampling frequencies may be used as well, according to the needs of a particular implementation, as will be understood by one of ordinary skill in the art.

The data set of subsampled pixels is then processed to determine a minimum value of the color channels for the subsampled pixels 32. For example, for a pixel having red, green, and blue (RGB) color channels, the values of each of these three color channels are compared to determine a minimum value. For example, if a first pixel has RGB values of R=130, G=0, B=200, the minimum value for that pixel is 0. If a second pixel has RGB values of R=50, G=50, B=50, the minimum value for that pixel is 50. The image processing system then will determine a selected pixel having the greatest minimum value 33. For our first and second exemplary pixels just mentioned, the minimum value for the first pixel is 0, and the minimum value for the second pixel is 50, so the second pixel has the greatest minimum value. Accordingly, if these were the only pixels being considered, the second pixel would be the selected pixel. The image processing system then determines a value of A based on the selected pixel 34. According to some embodiments, the image processing system calculates an intensity value for the selected pixel using the values of the color channels for the selected pixel. It is known in the art to calculate an intensity value of a pixel by, for example, calculating a linear combination of the values of the red, green, and blue color channels. The calculated intensity can then be used as a value of A. In accordance with the convention that

A should fall in a range between 0 and 1, the value of A may be normalized to represent a percentage of maximum intensity.

The process just described for determining a value of A is further demonstrated in the following pseudocode:

```
for y = 0 to height−1 (stepping by samplesize, e.g., 16)
  for x = 0 to width−1 (stepping by samplesize, e.g., 16)
  if min(inpixel(x,y).red,inpixel(x,y).green,inpixel(x,y).blue)>highestMin
    save inpixel, new highestMin
A = intensity of pixel with highestMin
```

An alternative process for determining a value of A for use in estimating the transmission characteristic used in the processes of FIGS. 2 and 2A is now described with reference to FIG. 3A. The pixels in the image data belong to a series of blocks of pixels. For example, the blocks may be 15 pixels wide by 15 pixels high. Image data describing a 150 pixel by 150 pixel image would then contain 100 blocks of pixels. The image is 10 blocks wide (15×10=150), and 10 blocks high (10×10=100). In each block, the pixels are processed to determine the pixel having the minimum intensity in that block 31A. In our example above, 100 pixels will be identified, one from each block. For each block, the intensity of each pixel is calculated, and the pixel in the block having the smallest intensity is selected. Once the minimum-intensity pixels are determined for each block of pixels, the image processing system determines the block having the greatest intensity for its minimum-intensity pixel 32A. If, for example, the highest intensity of the 100 selected pixels is the pixel selected from block 25, then block 25 has the greatest minimum-intensity. The image processing system then determines a value of A based on the selected pixel in the selected block 33A. In our example, the pixel that was selected as having the minimum intensity in block 25, which was a greater intensity than any other minimum intensity pixel from any other block. The intensity of this selected pixel may then be used as a value of A. In accordance with the convention that A should fall in a range between 0 and 1, the value of A may be normalized to represent a percentage of maximum intensity.

The process just described for determining a value of A is further demonstrated in the following pseudocode:

```
for block = 0 to number of blocks
  for x = 0 to blockwidth
    for y = 0 to blockheight
    if intensity of pixel(x,y) < minIntensity
    save pixel(x,y), new minIntensity
if minIntensity of current block > maxMinIntensity
save current block, new maxMinIntensity
A = intensity minIntensity of block with maxMinIntensity
```

The two procedures for determining a value of A described above are exemplary. Other procedures may be followed as well, according to the specific requirements of an embodiment of the invention. A value of A may be estimated from a most haze-opaque pixel. This may be, for example, a pixel having the highest intensity of any pixel in the image. The procedure of FIG. 3A includes determining a minimum intensity pixel in each of a plurality of blocks of pixels, and determining the highest intensity of the minimum pixels. This procedure also could be modified to include determining a minimum color channel value in the minimum intensity pixel in each of the blocks, and determining the highest value of the minimum color channel values. The procedure could be further modified to include selecting several of the pixels having the highest values of the minimum color channel values, and not just the one highest value. Then intensity values may be compared for these pixels, and the pixel having the highest intensity may be selected. Other variations and modifications in addition to the procedures given here will be apparent to one of ordinary skill in the art.

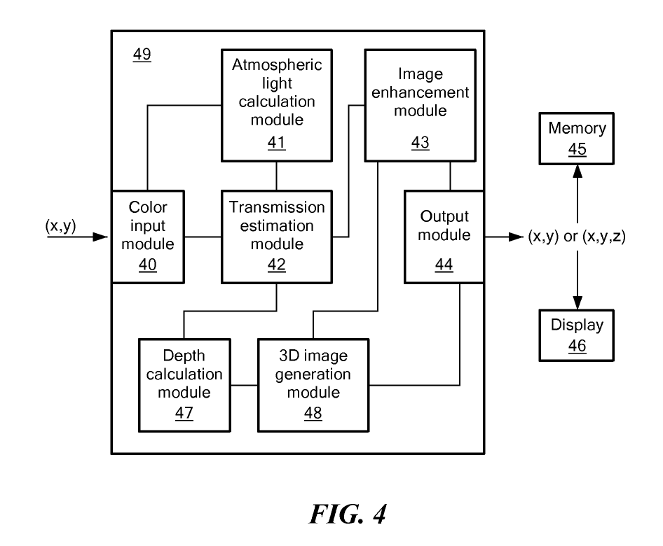

An image processing system in accordance with an embodiment of the present invention is now described with reference to FIG. 4. An image processing system 49 receives input image data in a color input module 40. The input image data contains a plurality of pixels having associated (x,y) coordinates. The image processing system 49 passes the image data from the input module 40 to an atmospheric light calculation module 41 and to a transmission estimation module 42. The atmospheric light calculation module 41 processes the image data to generate a value of A according to one of the methods described above and delivers the value of A to the transmission estimation module 42. The transmission estimation module estimates a transmission of the input image using the input image data and the value of A.

The transmission estimation module then delivers the input image data, the value of A, and the estimated transmission to at least one of an image enhancement module 43 and a depth calculation module 47. When the image enhancement module 43 receives data, it enhances the image data as described above with respect to FIG. 2, and provides the resulting enhanced image data to an output module 44. When the depth calculation module receives 47 data, it generates a depth map, as described above with respect to FIG. 2A, and provides the depth map and image data to a 3D image generation module 48. The 3D image generation module 48 processes the depth map and image data to generate 3D image data, which is passed to the output module 44. In some cases the image processing system 49 may generate image data that is both enhanced and converted to 3D by passing the output of the image enhancement module 43 to the 3D image generation module 48 or vice versa, after which the enhanced 3D image data is generated and passed to the output module 44. The output module then outputs the output image data, which may be 2D data or 3D data, based on whether 3D image generation was performed.

The output image data may be sent to memory 45 for storage. The memory 45 may be RAM or other volatile memory in a computer, or may be a hard drive, tape backup, CD-ROM, DVD-ROM, or other appropriate electronic storage. The output image data also may be sent to a display 46 for viewing. The display 46 may be a monitor, television screen, projector, or the like, or also may be a photographic printing device and the like for creating durable physical images. The display 46 also may be a stereoscope or other appropriate display device such as a holographic generator for viewing 3D image data. Alternatively, 3D image data may be sent to a 3D printer, e.g. for standalone free-form fabrication of a physical model of the image data.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or temporarily in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), or other memory device. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method of processing digital input image data containing haze and having a plurality of color channels including at least a blue channel, to generate output image data having reduced haze, the method comprising:
in a first computer-implemented process, receiving the digital input image data;
in a second computer-implemented process, generating digital output image data based on the digital input image data using an estimated transmission vector for the digital input image data, wherein the estimated transmission vector is substantially equal to an inverse blue channel of the digital input image data, and wherein the digital output image data contains less haze than the digital input image data; and
outputting the digital output image data via an output device.

2. A method according to claim 1, wherein the blue channel is normalized.

3. A method according to claim 2, wherein normalizing the blue channel includes dividing the values of the blue channel by a constant that represents light scattered in the input image data.

4. A method according to claim 1, wherein the input image data is a photographic image, wherein generating digital output image data includes solving the equation:
t(x, y)=J(x,y)*t(x,y)+A*(1−t(x,y))
to determine a value of J, where I is a color vector of the input image, J is a color vector that represents light from objects in the input image, t is the estimated transmission vector associated with the input image, and A is a constant that represents light scattered in the input image data.

5. A method according to claim 4, wherein solving the equation includes determining a value of A by subsampling pixels in the digital image data.

6. A method according to claim 4, wherein determining a value of A includes:
determining a selected pixel corresponding to A.

7. A method according to claim 4, wherein determining a value of A includes:
determining a minimum value for each of the plurality of color channels for each sampled pixel;
determining a selected pixel of the sampled pixels for which the minimum value is a highest minimum value; and
determining a value of A based on the selected pixel.

8. A method according to claim 4, wherein determining a value of A includes:
for each of a plurality of blocks of pixels, selecting a pixel having a smallest intensity of the pixels in the block;
determining a pixel of the selected pixels with a greatest intensity; and
determining a value of A based on the pixel having the greatest intensity.

9. A method according to claim 1, wherein the digital input image data includes a series of input images, and wherein generating digital output image data includes generating a series of output images having reduced haze.

10. A computer-implemented method of processing two-dimensional digital input image data having a plurality of color channels including at least a blue channel, to generate three-dimensional output image data, the method comprising:
in a first computer-implemented process, receiving the two-dimensional digital input image data;
in a second computer-implemented process, generating a depth map of the input image based on an estimated transmission vector is substantially equal to an inverse blue channel of the digital input image data;
in a third computer-implemented process, generating three-dimensional digital output image data based on the two-dimensional digital input image data using the depth map; and
outputting the three-dimensional digital output image data via an output device.

11. A method according to claim 10, wherein generating a depth map includes determining depth values for pixels in the input image based on the formula
d(x, y)=−β*ln(t(x, y))
wherein d(x,y) is a depth value for a pixel at coordinates (x,y), β is a scatter factor, and t(x,y) is the transmission vector.

12. A method according to claim 11, wherein β is determined based on a known distance from a camera that created the input image to an object represented at a predetermined pixel of the input image.

13. A method according to claim 12, wherein the predetermined pixel is a center pixel.

14. A method according to claim 10, further including generating a three-dimensional haze-reduced image based on the depth map and the digital output image data.

15. A method according to claim 9, wherein generating a series of output images further includes:
generating three-dimensional video output having reduced haze by generating a series of two-dimensional digital images;
generating depth maps for the series of digital images; and
generating a series of three-dimensional haze-reduced images based on the series of two-dimensional digital images and the depth maps.

16. A computer-implemented method for filtering light scattered as the result of the atmosphere from a photographic image composed of digital data, the method comprising:
in a first computer-implemented process, determining a transmission characteristic of the light present when the photographic image was taken based on a single color;
in a second computer-implemented process, applying the transmission characteristic to the data of the photographic image to filter the scattered atmospheric light producing an output image data set; and
storing the output image data set in a digital storage medium.

17. A computer-implemented method for producing a three-dimensional image data set from a two-dimensional photographic image composed of digital data, the method comprising:
in a first computer-implemented process, determining a transmission characteristic of the light present when the photographic image was taken based on a single color;
in a second computer-implemented process, applying the transmission characteristic to the data of the photographic image to generate a depth map for the photographic image;
in a third computer-implemented process, applying the depth map to the photographic image to produce a three-dimensional output image data set; and
storing the output image data set in a digital storage medium.

18. A non-transitory computer-readable storage medium with an executable program stored thereon for processing digital input image data containing haze and having a plurality of color channels including at least a blue channel, to generate output image data having reduced haze, wherein the program instructs a microprocessor to perform the following steps:
in a first computer-implemented process, receiving the digital input image data;
in a second computer-implemented process, generating digital output image data based on the digital input image data using an estimated transmission vector for the digital input image data, wherein the estimated transmission vector is substantially equal to an inverse blue channel of the digital input image data, and wherein the digital output image data contains less haze than the digital input image data; and
outputting the digital output image data via an output device.

19. A method according to claim 18, wherein the input image data is a photographic image, wherein generating digital output image data includes solving the equation:
I(x, y)=J(x,y)*t(x,y)+A*(1−t(x,y))
to determine a value of J, where I is a color vector of the input image, J is a color vector that represents light from objects in the input image, t is the estimated transmission vector associated with the input image, and A is a constant that represents light scattered in the input image data.

20. A method according to claim 19, wherein determining a value of A includes:
determining a minimum value for each of the plurality of color channels for each sampled pixel;
determining a selected pixel of the sampled pixels for which the minimum value is a highest minimum value; and
determining a value of A based on the selected pixel.

21. A method according to claim 19, wherein determining a value of A includes:
for each of a plurality of blocks of pixels, selecting a pixel having a smallest intensity of the pixels in the block;
determining a pixel of the selected pixels with a greatest intensity; and
determining a value of A based on the pixel having the greatest intensity.

22. A non-transitory computer-readable storage medium with an executable program stored thereon for processing two-dimensional digital input image data having a plurality of color channels including at least a blue channel, to generate three-dimensional output image data, wherein the program instructs a microprocessor to perform the following steps:
in a first computer-implemented process, receiving the two-dimensional digital input image data;
in a second computer-implemented process, generating a depth map of the input image based on an estimated transmission vector is substantially equal to an inverse blue channel of the digital input image data;
in a third computer-implemented process, generating three-dimensional digital output image data based on the two-dimensional digital input image data using the depth map; and
outputting the three-dimensional digital output image data via an output device.

23. A method according to claim 22, wherein generating a depth map includes determining depth values for pixels in the input image based on the formula
d(x, y)=−β*ln(t(x, y))
wherein d(x,y) is a depth value for a pixel at coordinates (x,y), β is a scatter factor, and t(x,y) is the transmission vector.

24. An image processing system, comprising:
a color input module that receives digital input image data containing haze and having a plurality of color channels including at least a blue channel;
an atmospheric light calculation module that receives digital input image data from the color input module and calculates atmospheric light information;
a transmission estimation module that receives the digital input image data from the color input module, receives atmospheric light information from the atmospheric light calculation module, and estimates a transmission characteristic of the digital input image data based on a single color channel;
an image enhancement module that receives digital input image data, atmospheric light information and the transmission characteristic and generates output image data having reduced haze; and
an output module that receives the output image data from the image enhancement module and outputs the output image data to at least one of a digital storage device and a display.

25. An image processing system, comprising:
a color input module that receives two-dimensional digital input image data having a plurality of color channels including at least a blue channel;
an atmospheric light calculation module that receives digital input image data from the color input module and calculates atmospheric light information;
a transmission estimation module that receives the digital input image data from the color input module, receives atmospheric light information from the atmospheric light calculation module, and estimates a transmission characteristic of the digital input image data based on a single color channel;
a depth calculation module that receives the digital input image data and the transmission characteristic and calculates a depth map using the digital input image data and the transmission characteristic;
a three-dimensional image generation module that receives the digital input image data and the depth map and generates three-dimensional output image data using the digital input image data and the depth map; and
an output module that receives the three-dimensional output image data and outputs the three-dimensional output image data to at least one of a digital storage device and a display.
